(19) United States
(12) Patent Application Publication
(10) Pub. No.: US 2016/0341317 A1
(43) Pub. Date: Nov. 24, 2016

(54) MECHANICAL SEAL ARRANGEMENT HAVING IMPROVED FLOW BEHAVIOUR FOR A COOLING AND/OR SEALING MEDIUM

(71) Applicant: EagleBurgmann Germany GmbH & Co. KG, Wolfratshausen (DE)

(72) Inventors: Joseph Fichtner, Wolfratshausen (DE); Stefan Ledig, Wolfratshausen (DE); Alfred Matuschek, Geretsried (DE); Ernst Pochmann, Kochel Am See (DE); Joachim Skrzidlo, Wolfratshausen (DE)

(21) Appl. No.: 15/151,807

(22) PCT Filed: Oct. 27, 2014
(86) PCT No.: PCT/EP2014/072963

§ 371 Date: May 11, 2016

(30) Foreign Application Priority Data
Nov. 14, 2013 (DE) 10 2013 223 226.8

(51) Int. Cl. F16J 15/34

(52) U.S. Cl. CPC F16J 15/3404

(57) ABSTRACT

The present invention relates to a mechanical seal arrangement comprising: a mechanical seal (2) having a rotating slide ring (3) and a stationary slide ring (4) which define a sealing gap (5) therebetween, and a housing component (6) having an inner peripheral region (60), wherein the housing component (6) includes an outlet opening (7) for discharging a fluid, guided to the slide rings, and an inflow region, and wherein the inflow region comprises at least one transition channel (8; 9) which extends in the circumferential direction, becomes continually deeper towards the outlet opening (7), is formed in the housing component (6) and opens at the outlet opening (7).

The present invention relates to a mechanical seal arrangement having an improved flow behaviour for a medium supplied to the slide rings of a mechanical seal, more particularly a cooling and/or sealing medium.

Mechanical seal arrangements are known from the prior art in different designs. Typically, mechanical seal arrangements are supplied with a cooling and/or sealing medium which is conveyed by means of internal conveying devices. An example of this is known from DE 10 2011 118 294.6, wherein a tesla pump is used therein as the internal conveying device. Other conveying devices include, for example, pump rings. A fluid path extends from the internal conveying device to the slide rings from where it is discharged via an exit bore in a housing. The exit bore is, in this case, provided radially with respect to the slide rings. However, the fluid supplied to the mechanical seal must undergo several changes in direction owing to the rotation of the rotating slide ring and the axial supply, whereby flow losses may occur in the fluid. However, a greater power must therefore be applied by the internal conveying device. In particular, the fluid is accelerated in the peripheral direction in the region of the mechanical seal owing to the rotating slide ring, but must then be radially discharged.

It is thus the object of the present invention to provide a mechanical seal arrangement which allows internal losses in a fluid supplied to the slide rings to be reduced whilst having a simple design and being simple and cost-effective to produce.

This object is achieved by a mechanical seal arrangement having the features of claim 1. Preferred developments of the invention are described in the dependent claims.

The mechanical seal arrangement in accordance with the invention having the features of claim 1 is advantageous in that flow losses of a fluid supplied to the slide rings of a mechanical seal, such as, for example, a sealing medium or a cooling medium, are significantly reduced. A low-loss flow is achieved in this case within the mechanical seal arrangement, whereby in particular a mass flow of the supplied fluid can be increased with a conveying device having the same drive power. As a result, for example, an improved cooling effect can be achieved on the slide rings without as a result dimensions having to be increased for an outflow bore in a housing or the power of an internal conveying device having to be increased. In accordance with the invention, the mechanical seal arrangement comprises, in addition to the mechanical seal having a rotating slide ring and a stationary slide ring, a housing component having an inner, cylindrical peripheral region. The housing component comprises an outlet opening for discharging the fluid supplied to the slide ring and an inflow region. The inflow region allows, in accordance with the invention, flow losses to be reduced in the region of the entrance of the outlet opening. The inflow region includes at least one transition channel which extends in the circumferential direction and becomes continually deeper towards the outlet opening. This transition channel is formed in the housing component on the inner, cylindrical peripheral region and opens into the outlet opening.

In a particularly preferred manner, the outlet opening is arranged in the radial direction outside of the slide rings. In a particularly preferred manner, the outlet opening lies in the radial direction completely over the rotating slide ring or over the sealing gap. The fluid accelerated in the circumferential direction by the rotating slide ring is hereby supplied into the transition channel and then into the outlet opening with reduced flow losses.

The mechanical seal arrangement preferably further includes an internal conveying device. In a particularly preferred manner, the internal conveying device is a pump ring or a tesla pump. In a particularly preferred manner, the transition channel(s) of the outlet opening lie(s) in the radial direction over the internal conveying device. This ensures that the fluid conveyed by the internal conveying device can flow directly into the transition channels and thus the outlet opening. Preferably, the outlet opening is arranged radially outside and over the internal conveying device. In a further preferred manner, it is possible for two internal conveying devices to also be provided, said conveying devices being connected one behind the other, e.g. a pump ring and a tesla pump.

It is further preferred for the outlet opening to be oriented at an angle to the radial direction of the slide rings and for the transition channel to open into the outlet opening thus inclined with respect to the radial direction. In a particularly preferred manner, the outlet opening includes an intake region inclined with respect to the radial direction of the slide rings and a main region extending in the radial direction, wherein preferably the inflow occurs into the inclined intake region of the outlet opening.

In accordance with a further preferred embodiment of the invention, the mechanical seal arrangement further includes a second transition channel which extends in the circumferential direction, becomes continually deeper towards the outlet opening and is arranged on a side of the outlet opening opposite the first transition channel. As a result, a fluid supplied to the slide ring can be discharged more effectively independently of the direction of rotation. The two transition channels lie opposite each other at the outlet opening, and therefore an improved inflow into the outlet opening is achieved in each case independently of the direction of rotation. In a particularly preferred manner, the first and second transition channels are arranged symmetrically with respect to the outlet opening.

It is further preferred if the outlet opening comprises first and second intake regions which both open into a common main region. The first and second intake regions are arranged symmetrically with respect to a centre line of the main region. This design is likewise suitable, in a particularly preferred manner, for an inflow of fluid independently of the direction of rotation. The two intake regions are preferably formed symmetrically and each of the intake regions includes its own transition channel.

In a particularly preferred manner, the transition channel is formed such that a base of the transition channel lies in a plane. On the one hand, an effective inflow of the fluid to the outlet opening is hereby achieved and on the other hand the transition channel can be produced in a very simple and cost-effective manner, for example by means of a chip-removing method.

For improved flow, a transition region between the transition channel and the outlet opening is preferably formed as an arcuate deflection contour. A soft transition from the transition channel into the outlet opening can hereby be achieved.

It is further preferred if the mechanical seal arrangement includes precisely one outlet opening. Hereby, only precisely one outlet opening needs to be provided in the housing component in order for sufficient space to remain in the housing component for further elements and openings, e.g. for attaching the housing or additional fluid channels or the like.

Preferably, the outlet opening includes a main region and an intake region, wherein the intake region is arranged at an angle to the main region and centre axes of the main region and of the intake region lie in a common plane which is perpendicular to the longitudinal axis of the mechanical seal arrangement. Alternatively, the intake region can also be provided to be inclined, in the axial direction of the mechanical seal arrangement, with respect to the radially extending main region.

Preferred exemplified embodiments of the invention will be described in detail hereinafter with reference to the accompanying drawings. Like components, or components acting in a functionally identical manner, are designated by like reference numerals. In the drawing:

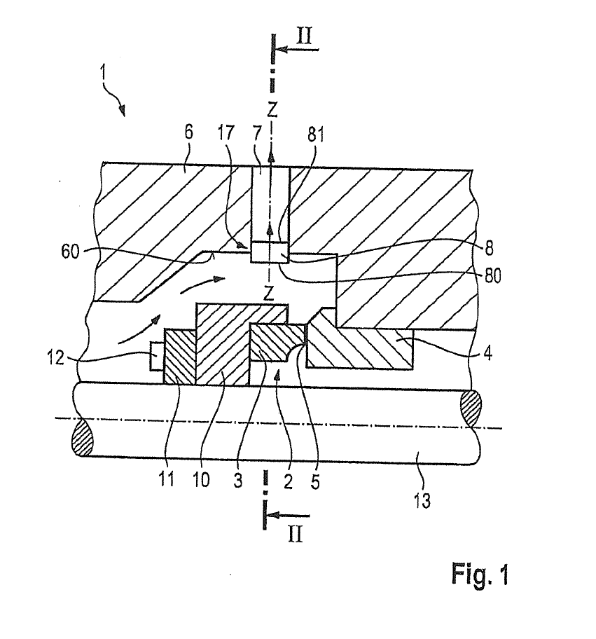

FIG. 1 shows a schematic view of a mechanical seal arrangement in accordance with a first exemplified embodiment of the invention,

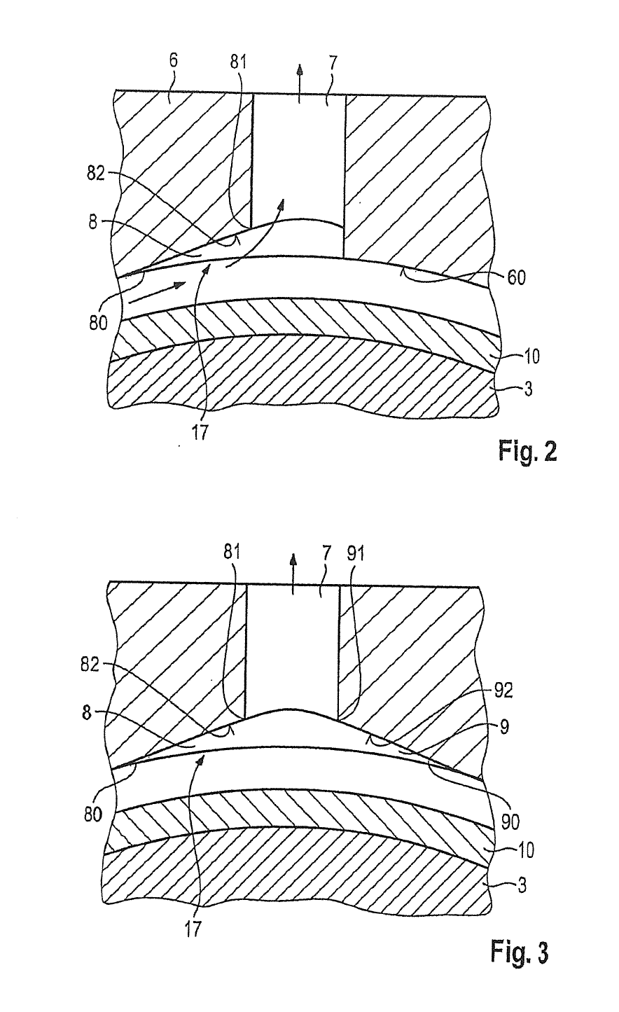

FIG. 2 shows a schematic sectional view along line II-II of FIG. 1,

FIG. 3 shows a schematic sectional illustration of an outlet opening of a mechanical seal arrangement in accordance with a second exemplified embodiment of the invention,

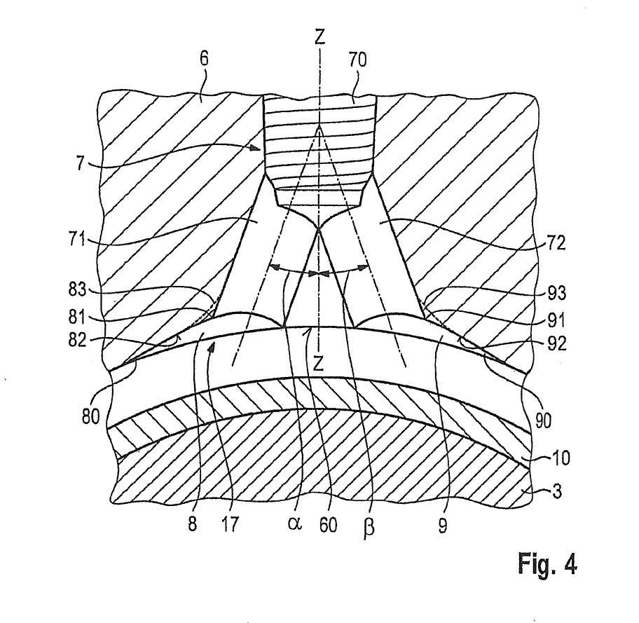

FIG. 4 shows a schematic sectional illustration of an outlet opening of a mechanical seal arrangement in accordance with a third exemplified embodiment of the invention,

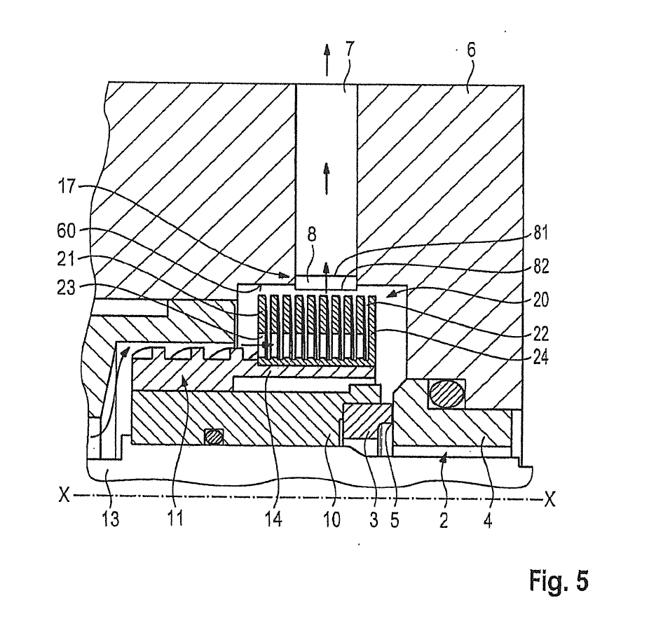

FIG. 5 shows a mechanical seal arrangement in accordance with a fourth exemplified embodiment of the invention, and

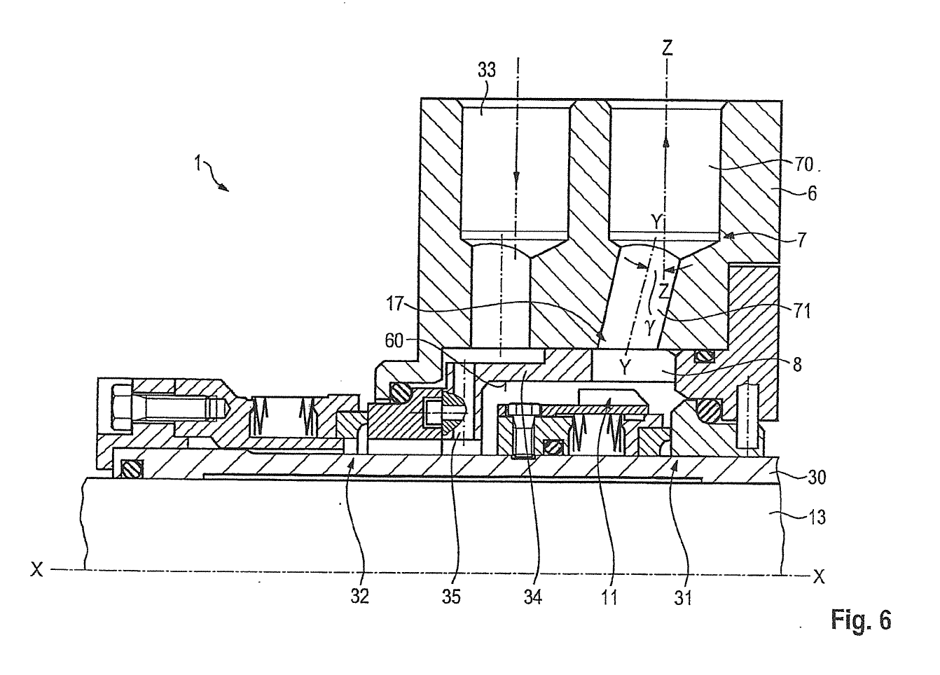

FIG. 6 shows a mechanical seal arrangement in accordance with a fifth exemplified embodiment of the invention.

A mechanical seal arrangement 1 in accordance with a first exemplified embodiment of the invention will be described in detail hereinafter with reference to FIGS. 1 and 2.

As can be seen in FIG. 1, the mechanical seal arrangement 1 includes a mechanical seal 2 having a rotating slide ring 3 and a stationary slide ring 4. The two slide rings define a sealing gap 5 therebetween.

The stationary slide ring 4 is fixed to a housing component 6.

The rotating slide ring 3 is connected to a shaft 13 via an entrainment element 10. The entrainment element 10 thereby transfers a torque from the shaft 13 to the rotating slide ring 3.

Furthermore, an internal conveying device 11 having blades 12 is arranged on the shaft 13. The internal conveying device 11 rotates together with the shaft 13 and is used to convey a fluid to the mechanical seal 2. The fluid can be, for example, a sealing medium or a coolant. The fluid flow is designated in FIGS. 1 and 2 by arrows.

An outlet opening 7 is also provided in the housing component 6. The outlet opening 7 is oriented in the radial direction Z-Z of the slide rings and is used to discharge the fluid. An inner, cylindrical peripheral region 60 is formed in this case on the housing component 6. The outlet opening 7 extends in this case radially outwards from the inner, cylindrical peripheral region 60. The outlet opening 7 is provided radially outside and over the rotating slide ring 3.

An inflow region 17 having an open transition channel 8 is also formed on the inner, cylindrical peripheral region 60 in the region of the outlet opening 7. The transition channel 8 can be seen in detail in FIG. 2. The transition channel 8 extends in the circumferential direction and opens into the outlet opening 7. The transition channel 8 includes an entrance region 80 from the cylindrical peripheral region 60 into the transition channel 8 and a transition region 81 to the outlet opening 7 (cf. FIG. 2). A base 82 of the transition channel 8 is formed to be flat. The transition channel 8 can be produced on the inner, cylindrical peripheral region 60 of the housing component 6 by means of a chip-removing method for example. It should be noted that the base 82 can also be provided to be arcuate.

The transition channel 8 oriented in the circumferential direction thus allows improved inflow of the fluid into the outlet opening 7. In particular, the transition channel 8 allows a directed inflow of the fluid into the radial outlet opening 7, and therefore flow losses can be reduced. Therefore, a significant increase in the through-flow amount can be achieved with the outlet opening 7 having the same diameter by providing the transition channel 8, compared with an outlet opening which does not have a transition channel 8. Therefore, a conveying power can be increased with an identical conveying device 11, or an internal conveying device 11 can be provided with reduced conduction, whereby in particular an energy consumption of the internal conveying device 11 can be reduced.

In accordance with the invention, an increased volumetric flow of the fluid can therefore be achieved with otherwise identical dimensions, and therefore, for example, improved cooling of the mechanical seal 2 can be achieved. It is also possible in accordance with the invention for merely precisely one outlet opening 7 to be provided in the housing component 6, and therefore the remaining structural space in the housing component 6 can be used for other purposes, e.g. for providing further fluid channels and/or fastening elements or the like.

FIG. 3 shows a section of a mechanical seal arrangement according to a second exemplified embodiment of the invention. In contrast to the first exemplified embodiment, the mechanical seal arrangement of the second exemplified embodiment is independent of rotation. In this respect, a first transition channel 8 and a second transition channel 9 are provided on the radial outlet opening 7. The transition channels 8, 9 are arranged symmetrically on the outlet opening 7.

As can be seen in FIG. 3, the two transition channels 8, 9 lie opposite each other at the outlet opening 7 and are both oriented in the circumferential direction. Therefore, an improved inflow to the radial outlet opening 7 can be achieved in each case independently of a direction of rotation. The two transition channels 8, 9 open directly into the radial outlet opening 7. The second transition channel 9 likewise includes a flat base 92, an entrance region 90 from the inner, cylindrical peripheral region 60 into the transition channel 9 and a transition region 91 to the outlet opening 7.

Therefore, in the second exemplified embodiment, an improved incident flow to the radial outlet bore 7 can be obtained independently of the direction of rotation of the mechanical seal. The two transition channels 8, 9 are formed symmetrically with respect to the outlet opening 7.

FIG. 4 shows a section of a mechanical seal arrangement in accordance with a fourth exemplified embodiment of the invention. In the fourth exemplified embodiment, the outlet opening 7 includes a main region 70, a first intake region 71 and a second intake region 72. The main region 70 is oriented radially with respect to the slide rings. The first intake region 71 is arranged in this case at an angle α to the main region 70 and the second intake region 72 is arranged at an angle β to the main region 70. The two angles α and β are the same size but have a different algebraic sign. Furthermore, a first transition channel 8 and a second transition channel 9 are provided. The first transition channel 8 opens into the first intake region 71 and the second transition channel 9 opens into the second intake region 72. Therefore, in this exemplified embodiment, an outflow of the fluid occurs, likewise independently of the direction of rotation. However, after entering the transition channel, the fluid initially enters an intake region and then the main region 70. A through-flow amount can be further increased hereby. In particular, flow losses can be reduced by the design of the intake regions 71, 72 which are inclined, in the circumferential direction, with respect to the radial direction Z-Z. Furthermore, the diameters of the intake regions 71, 72 are each smaller than a diameter of the main region 70. It should be noted that it is, of course, also possible to provide a design having a main region 70 and one of the intake regions only in one circumferential direction, starting from the main region 70.

The dotted lines in FIG. 4 indicate a still further alternative embodiment of the invention, wherein arcuate deflection contours 83, 93 are formed at the transition region 81 and 91 respectively. The arcuate transition contours 83, 93 provide a transition from the transition channel 8, 9 to the respective intake regions 71, 72 in a manner as favourable to flow as possible. An arc of the deflection contours 83, 93 is preferably selected such that there is no disruptive transition edge between the deflection contours 83, 93 and the regions adjoining them.

FIG. 5 shows a mechanical seal arrangement in accordance with a fourth exemplified embodiment of the invention. The mechanical seal arrangement in accordance with the fourth exemplified embodiment includes a first internal conveying device 11 in the form of a pump ring and a second internal conveying device in the form of a tesla pump 20. As can be seen in FIG. 5, the pump ring and the tesla pump 20 are arranged on a common sleeve 14 which is connected to the entrainment element 10. The tesla pump 20 includes a multiplicity of parallel discs 21 which each comprise an axial opening 23. The axial openings 23 are cylindrical and are arranged distributed evenly along the circumference of the discs 21. Intermediate spaces 22 are provided between each of the individual discs 21. Furthermore, an axial end disc 24 of the tesla pump 20 is provided and does not have a passage opening. As shown by the arrows in FIG. 5, the fluid is thus first conveyed through the first internal conveying device 11 (pump ring) to the tesla pump 20 and from there into the passage openings 23. The fluid then exits the tesla pump 20 with an increased radial component and is then discharged via the transition channel 8 into the outlet opening 7 which is oriented in the radial direction of the slide rings. An inflow region 17 having a transition channel 8 corresponding to the first exemplified embodiment is again formed at the entrance region of the outlet opening 7. In this exemplified embodiment, a still further flow through the outlet opening 7 is achieved by way of the transition channel 8. A spacing between a radially outer circumferential surface of the tesla pump 20 and an inner, cylindrical peripheral region 60 of the housing component 6 can be relatively small such that an extremely compact structural shape is obtained. The outlet opening 7 is arranged radially outside and over the tesla pump 20, preferably in the axial direction in the centre of the tesla pump 20.

The fifth exemplified embodiment shown in FIG. 6 shows a mechanical seal arrangement in a tandem arrangement with a first mechanical seal 31 and a second mechanical seal 32. Reference numeral 30 designates a sleeve which rotates with the shaft 13. In this exemplified embodiment, a sealing fluid is supplied via an intake 33 and via a through-opening 35 which is provided in a sleeve component 34. An internal conveying device 11 in the form of a pump ring is provided for conveying the sealing fluid within the mechanical seal arrangement. The outlet opening 7 is formed, in a similar manner to the third exemplified embodiment of FIG. 4, with a first intake region 71 with a first transition channel 8 and a second intake region, not shown, with a second transition channel which cannot be seen in the sectional view of FIG. 6. A main region 70 of the outlet opening 7 is arranged in the radial direction Z-Z perpendicular to the shaft 13. A centre line Y-Y of the first intake region 71 and the second intake region is arranged at an angle γ to the radial direction Z-Z. As a result, the intake regions 7′ are provided to be inclined with respect to the axial direction X-X, whereby the flow behaviour can be further improved and, in particular, a flow loss can be reduced in the region of the entrance of the outlet opening 7. The transition channel 8 is provided in the sleeve component 34. However, it should be noted that the sleeve component 34 can also be omitted and the transition channel 8 can be provided in the housing component 6. In this exemplified embodiment, the intake regions are thus inclined in the circumferential direction and also in the axial direction X-X. Alternatively, the main region 70 of the outlet opening 7 can also be provided at an angle, which is not 90°, to the axial direction X-X.

It should be noted with respect to all the exemplified embodiments that in accordance with the invention a significantly improved flow of fluid from the slide rings into an outlet opening 7 can thus be achieved by providing one or more inflow regions 17 having transition channels 8, 9 in a cylindrical peripheral region 60. In particular, a sufficient mass flow of the fluid can be achieved by providing merely one single outlet opening 7. In particular, a housing structure of the housing component 6 can hereby be significantly simplified.

### LIST OF REFERENCE NUMERALS

1 Mechanical seal arrangement
2 Mechanical seal
3 Rotating slide ring
4 Stationary slide ring
5 Sealing gap
6 Housing component
7 Outlet opening
8 First transition channel
9 Second transition channel
10 Entrainment element
11 First internal conveying device
12 Blade
13 Shaft
14 Sleeve
17 Inflow region
20 Tesla pump (second internal conveying device)
21 Disc
22 Intermediate space
23 Passage opening
24 Closed end disc
30 Sleeve
31 First mechanical seal
32 Second mechanical seal
33 Intake
34 Sleeve component
35 Through-opening
60 Inner, cylindrical peripheral region
70 Main region
71 First intake region
72 Second intake region
80 Entrance region
81 Transition region
82 Base
83 Arcuate deflection contour
90 Entrance region
91 Transition region
92 Base
93 Arcuate deflection contour

1. Mechanical seal arrangement comprising:
a mechanical seal having a rotating slide ring and a stationary slide ring which define a sealing gap therebetween;
a housing component having an inner peripheral region;
wherein the housing component includes an outlet opening for discharging a fluid, guided to the slide rings, and an inflow region, and
wherein the inflow region comprises at least one first transition channel which extends in the circumferential direction, becomes continually deeper towards the outlet opening, is formed in the housing component and opens at the outlet opening.

2. Mechanical seal arrangement as claimed in claim 1, wherein the outlet opening is arranged radially outside and over the slide rings.

3. Mechanical seal arrangement as claimed in claim 1, further comprising at least one first internal conveying device for conveying the fluid.

4. Mechanical seal arrangement as claimed in claim 3, wherein the outlet opening is arranged radially outside and over the conveying device.

5. Mechanical seal arrangement as claimed in claim 3, comprising a first internal conveying device and a second internal conveying device.

6. Mechanical seal arrangement as claimed in claim 1, wherein the outlet opening extends exclusively in the radial direction.

7. Mechanical seal arrangement as claimed in claim 1, wherein the outlet opening comprises a main region extending in the radial direction and an intake region extending at an angle (α) to the radial direction, wherein the intake region opens into the main region.

8. Mechanical seal arrangement as claimed in claim 1, further comprising a second transition channel which is arranged at the outlet opening opposite the first transition channel.

9. Mechanical seal arrangement as claimed in claim 8, wherein the first transition channel and the second transition channel are formed symmetrically with respect to the outlet opening.

10. Mechanical seal arrangement as claimed in claim 1, wherein the outlet opening comprises a first intake region and a second intake region which both open into a common main region, wherein the first and second intake regions are provided symmetrically with respect to the main region.

11. Mechanical seal arrangement as claimed in claim 1, wherein the transition channel comprises a base which lies in a plane.

12. Mechanical seal arrangement as claimed in claim 1, wherein a transition region between the transition channel and the outlet opening is formed as an arcuate deflection contour.

13. Mechanical seal arrangement as claimed in claim 1, wherein a center axis (Y-Y) of the intake region and a center axis (Z-Z) of the main region lie in a common plane, and wherein the plane is perpendicular to a longitudinal axis (X-X) of the mechanical seal arrangement.

14. Mechanical seal arrangement as claimed in claim 1, wherein a centre center axis (Y-Y) of the intake region is inclined in the axial direction (X-X) and/or in the circumferential direction and intersects a plane, containing the center axis (Z-Z) of the main region, at an angle (γ).
